(19) United States
(12) Patent Application Publication
(10) Pub. No.: US 2005/0093511 A1
(43) Pub. Date: May 5, 2005

(54) Charger capable of providing illumination light

(76) Inventor: Wen-Ching Wu, Taoyuan Hsien (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/840,339

(22) Filed: May 6, 2004

(30) Foreign Application Priority Data
Nov. 3, 2003 (TW) 092219476

(51) Int. Cl. H02J 7/00

(52) U.S. Cl. 320/114

(57) ABSTRACT

A charger capable of providing illumination light is disclosed. The charger comprises a main body to be coupled with a power source for charging an electronic apparatus, an illumination device disposed on the main body for providing illumination light, and a control switch disposed on the main body and electrically coupled with the illumination device for controlling the illumination device to illuminate light.

### FIELD OF THE INVENTION

The present invention relates to a charger, and more particularly to a charger capable of providing illumination light.

### BACKGROUND OF THE INVENTION

With the progress of technology, various portable electronic apparatuses such as mobile phones, personal digital assistants (PDA) or notebook computers are frequently used in our daily life for contenting with user's needs of real-time communication and data management. However, the replenishment of electric power is apparently important for the portable electronic apparatuses to maintain their normal operation anytime and anywhere. Therefore, various kinds of chargers such as travel chargers, car chargers or seat chargers are developed and provided for charging the portable electronic apparatuses.

Take a car charger for a mobile phone as an example. Please refer to FIG. 1, which illustrates the structure of a traditional car charger. The traditional car charger mainly comprises a main body 11, an extensible connecting wire 12 and a contact terminal 13. In addition, an outward extended plug 111 is disposed on one side of the main body 11 and connecting to an external power source for receiving electric power from the external power source and transmitting the electric power to the main body 11. One end of the extensible connecting wire 12 is coupled with another side of the main body 11, and the other end of the extensible connecting wire 12 is coupled with the contact terminal 13. While the contact terminal 13 is electrically coupled with a mobile phone, the charger can receive the electric power from external power source via the outward extended plug 111, convert and transmit the electric power via the main body 11 and extensible connecting wire 12, and charge the mobile phone via the contact terminal 13. However, such a car charger merely provides the function of charging without other additional benefits for user.

Please refer to FIG. 2, which illustrates the structure of the other kind of traditional car charger. The car charger mainly comprises a main body 21, an extensible connecting wire 22 and a contact terminal 23. In addition, an outward extended plug 211 is disposed on one side of the main body 21 and connecting to an external power source for receiving the electric power from the external power source and transmitting the electric power to the main body 21. One end of the extensible connecting wire 22 is coupled with another side of the main body 21, and the other end of the extensible connecting wire 22 is coupled with the contact terminal 23. While the contact terminal 23 is electrically coupled with a mobile phone, the charger can receive the electric power from external power source via the outward extended plug 211, convert and transmit the electric power via the main body 21 and extensible connecting wire 22, and charge the mobile phone via the contact terminal 23.

Please refer to FIG. 2 again. There is an indication light 212 additionally disposed on the main body 21. The indication light 212 is employed to inform the user that the mobile phone is receiving a call when the indication light 212 illuminates light. Although the indication light 212 is disposed on the main body 21 of the car charger, the indication light 212 is merely employed to inform the user that the mobile phone is receiving a call.

In addition, in the other prior art, the indication light 212 disposed on the main body 21 is employed to inform that a mobile phone electrically connected with the charger is in the charge situation. While a mobile phone is charged via the charger, the indication light 212 illuminates red light to inform that the mobile phone is in the charge situation. While the indication light 212 turns to illuminate green light, it represents that the mobile phone is charged completely. However, such indication light 212 of the charger is merely employed to inform whether the mobile phone is in charge situation or not without other additional capabilities. It is not convenient for user when the environment light is not sufficient or the faint light in the car causes some dead corners of views. In addition, according to a general practice, people will not prepare flashlight with him or in the car. Therefore, it is desired for the user to have a charger capable of providing illumination light.

### SUMMARY OF THE INVENTION

The object of the present invention is to provide a charger capable of charging a portable electronic apparatus and providing illumination light to meet user's needs of illumination and charge at the same time.

In order to achieve the above-mentioned object, a charger capable of providing illumination light is provided. The charger comprises a main body to be coupled with a power source for charging an electronic apparatus, an illumination device disposed on the main body for providing illumination light, and a control switch disposed on the main body and electrically coupled with the illumination device for controlling the illumination device to illuminate light.

In an embodiment, the illumination device is a light bulb or a light emitted diode.

In an embodiment, the control switch is a slide switch, a key switch or a membrane switch.

In an embodiment, the power source is one of utility power source and battery.

In an embodiment, the main body further comprises a power connection device coupled with the power source for receiving the electric power from the power source and transmitting the electric power to the main body.

In an embodiment, one end of the power connection device is connected with the main body.

In an embodiment, the main body further comprises a contact terminal coupled with the electronic apparatus for charging the electronic apparatus.

In an embodiment, the electronic apparatus is a portable electronic apparatus. Preferably, the portable electronic apparatus is one selected from a group consisting of a mobile phone, a digital audio recorder and a personal digital assistant.

In an embodiment, the charger is one selected from a group consisting of a car charger, a travel charger and a seat charger.

### BRIEF DESCRIPTION OF THE DRAWINGS

FIG. 1 is a schematic view illustrating a traditional car charger;

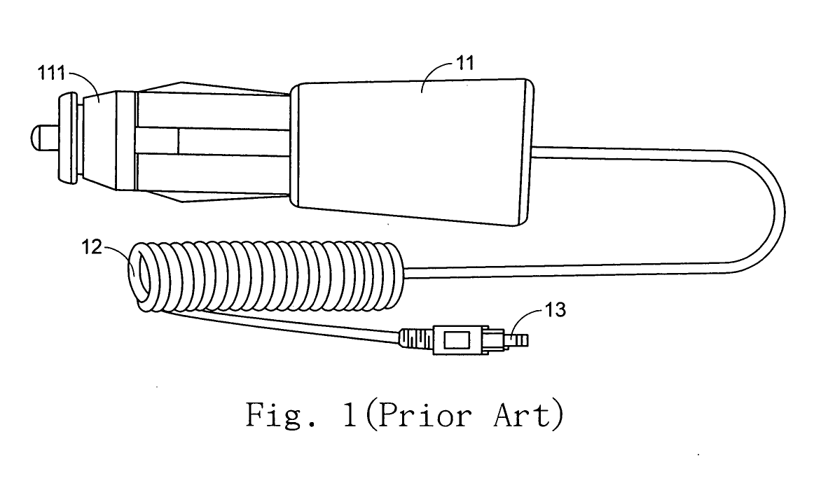

FIG. 2 is a schematic view illustrating the other kind of traditional car charger; and

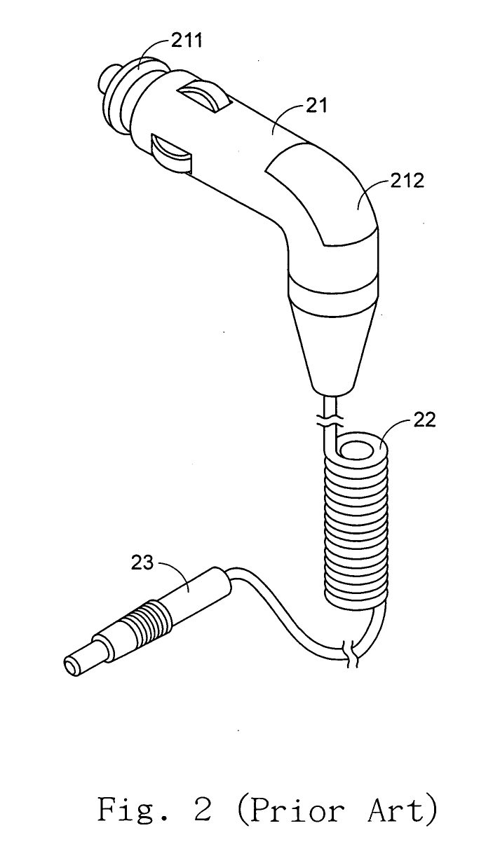

FIG. 3 is a schematic view showing a car charger according to a preferred embodiment of the present invention.

### DETAILED DESCRIPTION OF THE PREFERRED EMBODIMENT

The present invention relates a charger capable of providing illumination light. The charger of the present invention can provide the functions of charge and illumination. The present invention will be described more specifically with reference to the following embodiments of car charger. It is to be noted that the following description of the preferred embodiment of this invention is presented herein for purpose of illustration and description only; it is not intended to be exhaustive or to be limited to the precise form disclosed. On the contrary, other kinds of charger structures for portable electronic apparatuses, such as travel chargers or seat chargers for mobile phones, digital audio recorders or personal digital assistant (PDA), are also cooperated herewith for reference.

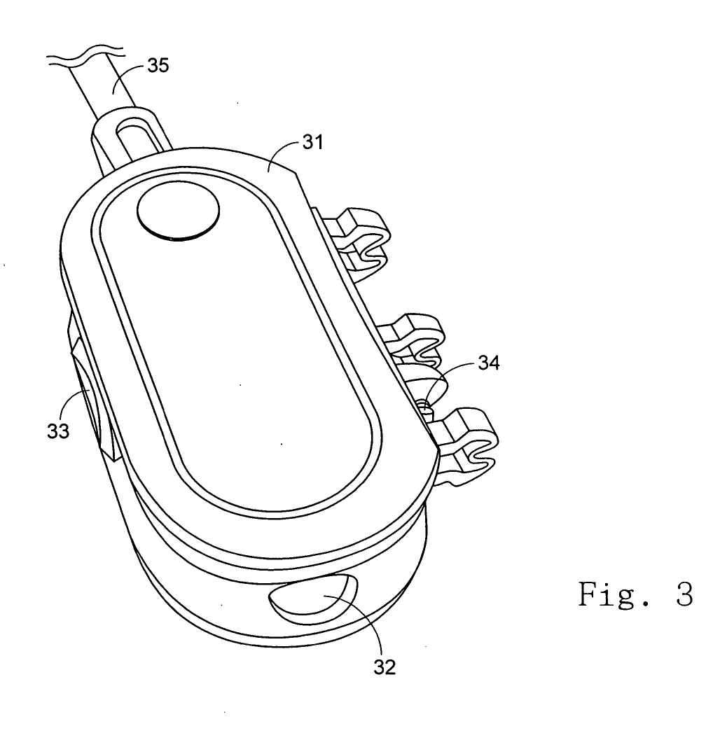

Please refer to FIG. 3, which illustrates a charger according to a preferred embodiment of the present invention. As shown in FIG. 3, the charger of the present invention comprises a main body 31, an illumination device 32 and a control switch 33. The illumination device 32 and the control switch 33 are all disposed on the main body 31 and separately coupled with a printed circuit board (not shown) inside the main body 31. The illumination device 32, which provides specific brightness of illumination light for user, is light bulb or light emitted diode (LED). The control switch 33 is electrically coupled with the illumination device 32 and can be switched between on and off to control the illumination of the illumination device 32. The control switch 33 is preferably a slide switch, a membrane switch or a key switch. When the control switch 33 is a slide switch, the illumination device 32 can illuminate light by switching the slide switch from off to on. Similarly, when the control switch 33 is a key switch, the illumination device 32 can illuminate light by pressing the push switch.

Please refer to FIG. 3 again. The main body 31 further comprises at least a contact terminal 34 disposed on the main body 31 and coupled with the printed circuit board inside the main body 31 (not shown). The contact terminal 34 is employed to couple with a portable electronic apparatus and deliver the electric power from the main body 31 to the portable electronic apparatus for charging the portable electronic apparatus, such as mobile phone.

Moreover, the main body 31 further comprises a power connection device 35 coupled with an external power source (not shown) for receiving the electric power from the external power source and delivering the electric power to the main body 31. In an embodiment, the charger is a car charger and the power connection device 35 is a power cord having a cigarette lighter plug at one end thereof (not shown). The other end of the power connection device 35 is connected with the main body 31. The cigarette lighter plug of the power connection device 35 can be plugged into a cigarette lighter socket of the car. The car charger can receive the electric power from the power source of the car via the power connection device 35, convert the electric power by the main body 31, charge the portable electronic apparatus via the contact terminal 34, illuminate light by the illumination device 32, and control the illumination device 32 by the control switch 33.

In another embodiment, the charger is a seat charger or a travel charger and the power connection device 35 is a plug or a cable having a plug at one end thereof (not shown). The plug of the charger can be plugged into a socket of an external power source. The charger can also receive the electric power from the external power source via the power connection device 35, convert the electric power by the main body 31, charge the portable electronic apparatus via the contact terminal 34, illuminate light by the illumination device 32, and control the illumination device 32 by the control switch 33.

In order to deal with any situation, such as no power source is available for the charger, the charger can be designed to have a battery inside the main body 31 (not shown). Therefore, when no power source is available for the charger, the charger can also charge the portable electronic apparatus by the electric power stored in the battery. It can not only promote usage of the charger but also avoid the charger from the embarrassment of no socket of external power source to plug in.

In another embodiment, the power connection device 35 is detachably connected with the main body 31 by engagement (not shown). When user needs some illumination light, the main body 31 is separated from the power connection device 35 and connected with a mobile phone via the contact terminal 34. The mobile phone can provide electric power to the main body 31 of the charger and allow the illumination device 32 to illuminate light. Therefore, the main body 31 of the charger can be regarded as a flashlight with him and promote the utility of the charger.

According to the above descriptions, the present invention provides a charger capable of providing and controlling illumination light by an illumination device and a control switch. The charger of the present invention not only promotes the utility of the charger but also increase the convenience for the user.

While the invention has been described in terms of what is presently considered to be the most practical and preferred embodiments, it is to be understood that the invention needs not be limited to the disclosed embodiment. On the contrary, it is intended to cover various modifications and similar arrangements include within the spirit and scope of the appended claims which are to accord with the broadest interpretation so as to encompass all such modification and similar structures.

1. A charger capable of providing illumination light, comprising:
a main body to be coupled with a power source for charging an electronic apparatus;
an illumination device disposed on the main body for providing illumination light; and
a control switch disposed on the main body and electrically coupled with the illumination device for controlling the illumination device to illuminate light.

2. The charger according to claim 1 wherein the illumination device is a light bulb.

3. The charger according to claim 1 wherein the illumination device is a light emitted diode.

4. The charger according to claim 1 wherein the control switch is a slide switch.

5. The charger according to claim 1 wherein the control switch is a key switch.

6. The charger according to claim 1 wherein the control switch is a membrane switch.

7. The charger according to claim 1 wherein the power source is one of utility power source and battery.

8. The charger according to claim 1 wherein the main body further comprises a power connection device coupled with the power source for receiving electric power from the power source and transmitting electric power to the main body.

9. The charger according to claim 8 wherein one end of the power connection device is connected with the main body.

10. The charger according to claim 1 wherein the main body further comprises a contact terminal coupled with the electronic apparatus for charging the electronic apparatus.

11. The charger according to claim 1 wherein the electronic apparatus is a portable electronic apparatus.

12. The charger according to claim 11 wherein the portable electronic apparatus is one selected from a group consisting of a mobile phone, a digital audio recorder and a personal digital assistant.

13. The charger according to claim 1 wherein the charger is one selected from a group consisting of a car charger, a travel charger and a seat charger.
